(19) United States
(12) Patent Application Publication
(10) Pub. No.: US 2026/0030275 A1
(43) Pub. Date: Jan. 29, 2026

(54) CONTEXT-AWARE INFORMATION RETRIEVAL

(71) Applicant: Intuit, Inc., Mountain View, CA (US)

(72) Inventors: Karelia Del Carmen PENA PENA, Wilmington, DE (US); Ankita SINHA, Mountain view, CA (US); Richard BECKER, St. Albert (CA); Elizabeth FIATOR, Toronto (CA)

(21) Appl. No.: 18/782,876

(22) Filed: Jul. 24, 2024

(51) Int. Cl. G06F 16/33

(52) U.S. Cl. CPC G06F 16/334

(57) ABSTRACT

Certain aspects of the disclosure provide for information retrieval that exploits context derived from document structure. Source documents can be preprocessed to identify fields and determine context attributes related to each field based on the structural layout of a source document. Resource documents can also be preprocessed to segment a resource document into passages and determine context related to the passages based on structural layout. Queries pertaining to a field can be enhanced by adding context metadata associated with the field. A query embedding can be generated and compared with previously generated passage embeddings to locate candidate matches based on similarity. A machine learning model can be provided with the top-ranked passages and tasked with re-ranking the passages based on relevancy to the original query. The highest re-ranked passage or set of passages can be output in response to the query.

### BACKGROUND

### Field

Aspects of the subject disclosure relate to automated retrieval and presentation of information that facilitates field completion.

### Description of Related Art

Completing forms with numerous fields can be challenging. Each field within a form serves as a data entry point and requests precise information. Tax forms, in particular, often use cryptic language and technical terms that elude ordinary understanding. Consider a “taxable interest” field. The field seems straightforward but can conceal layers of complexity, which can leave individuals confused as to what constitutes taxable interest and what is being requested. Instructions can be provided to guide users in completing a form. However, locating a specific piece of information needed to understand and complete a field can be challenging and time-consuming, given extensive documentation and similar terminology. Information can be buried amongst irrelevant details and similar but distinct terms. As a result, individuals spend considerable time manually reviewing documentation to identify the most applicable guidance for completing a field.

### SUMMARY

Certain aspects provide a method comprising receiving a query regarding a source document that comprises one or more fields, determining a field of the one or more fields referenced by the query, retrieving contextual metadata for the field, generating an enriched query by adding the contextual metadata to query text, generating a query embedding from the enriched query, determining similarity scores between the query embedding and passage embeddings, wherein the passage embeddings are based on passage text from one or more resource documents comprising contextual metadata, and identifying one or more passages based on the similarity scores that satisfy a threshold.

Certain aspects also provide a method comprising performing optical character recognition of a reference document to identify text, analyzing a layout of the reference document to identify one or more structural elements, segmenting the text of the reference document into passages based on the one or more structural elements, determining contextual metadata for each passage based on passage text and the one or more structural elements, and generating a passage embedding of the text and the contextual metadata for each passage in the reference document.

Other aspects provide processing systems configured to perform the aforementioned methods as well as those described herein; non-transitory, computer-readable media comprising instructions that, when executed by a processor of a processing system, cause the processing system to perform the aforementioned methods as well as those described herein; a computer program product embodied on a computer-readable storage medium comprising code for performing the aforementioned methods as well as those further described herein; and a processing system comprising means for performing the aforementioned method as well as those further described herein.

The following description and the related drawings set forth in detail certain illustrative features of one or more aspects.

### DESCRIPTION OF THE DRAWINGS

The appended figures depict certain aspects and are therefore not to be considered limiting of the scope of this disclosure.

FIG. 1 depicts an example implementation of an information retrieval system.

FIG. 2 is a block diagram of an example source document process component.

FIG. 3 is a block diagram of a resource document process component.

FIG. 4 is a flow chart diagram of an example method of source document processing.

FIG. 5 is a flow chart diagram of an example method of resource document processing.

FIG. 6 is a flow chart diagram of an example method of information retrieval.

FIG. 7 depicts an example processing system with which aspects of the present disclosure can be performed.

To facilitate understanding, identical reference numerals have been used, where possible, to designate identical elements common to the drawings. It is contemplated that elements and features of one embodiment may be beneficially incorporated in other embodiments without further recitation.

### DETAILED DESCRIPTION

Aspects of the subject disclosure provide apparatuses, methods, processing systems, and computer-readable mediums for layout and context based information retrieval.

Forms, such as tax forms, and accompanying instructions, as well as any other guidelines or documentation relevant to understanding and completing the forms, present unique challenges for information retrieval. When documents contain extensive content and use specialized or subtly differentiated terminology, matching specific questions or form fields to explanatory passages can be challenging.

Conventional search, matching, and natural language processing approaches fail when concepts are highly similar, yet meanings differ contextually. For example, basic keyword searching or matching fails to leverage contextual attributes and thus may return many irrelevant results that include related but non-matching terms. Similar issues arise for information retrieval techniques that utilize term embeddings and semantic matching.

Aspects described herein provide a technical solution for retrieving information for responding to a query when content is extensive and includes highly similar concepts that differ subtly. More specifically, extensive contextual attributes derived from document structure and visual layout can be employed. Queries and resource documents can be encoded with rich metadata, capturing each element's relationship and position within an overall documentation scheme. Structural analysis can be performed to extract fields, segment text, and associate contextual tags with passages based on attributes such as heading, sections, and formatting cues. By representing queries and passages using embeddings of enriched content and relationships, highly similar concepts can be disambiguated based on their contextual meaning. Matching embeddings according to similarity scores retrieves semantically pertinent passages. Re-ranking a set of semantically pertinent passages with a machine learning model enables further refinement of the rankings to identify passages that are more relevant and targeted to a query. Exploiting contextual information throughout processing enables more precise linking of queries to relevant explanatory materials within extensive documentation and efficient and accurate information retrieval.

### Example Information Retrieval System

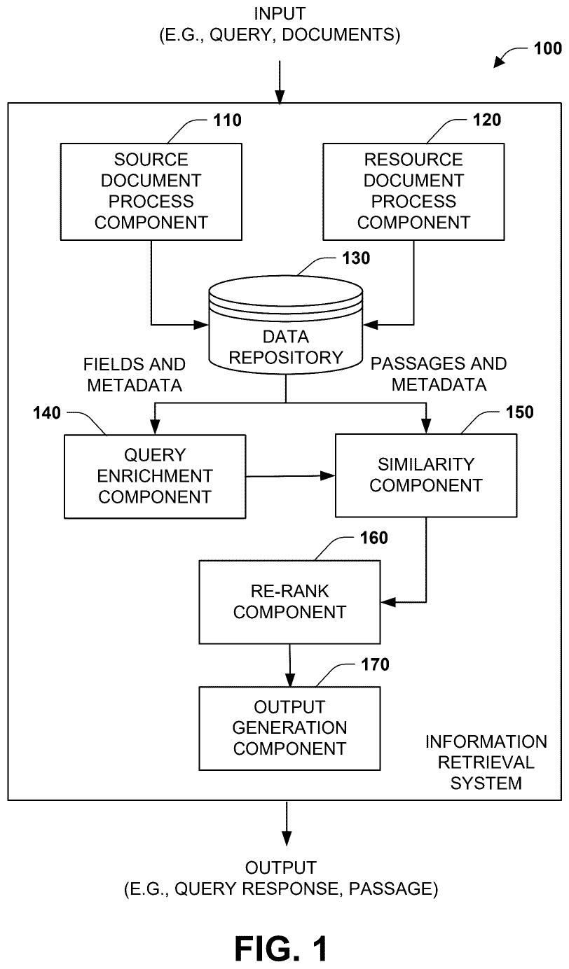

FIG. 1 depicts an example of an information retrieval system 100. The information retrieval system 100 exploits contextual relationships and document structure to map queries to relevant explanatory passages. Input to the information retrieval system 100 can comprise source documents, including fields, reference documents like instructions and guidelines, and queries. The information retrieval system 100 can output passages retrieved from resource documents deemed relevant to an input query alone or in combination with generated text or recommendations to assist a user in understanding and completing fields. In one instance, the information can output a document identifier or other reference to a document to allow a user to review the text in its entirety.

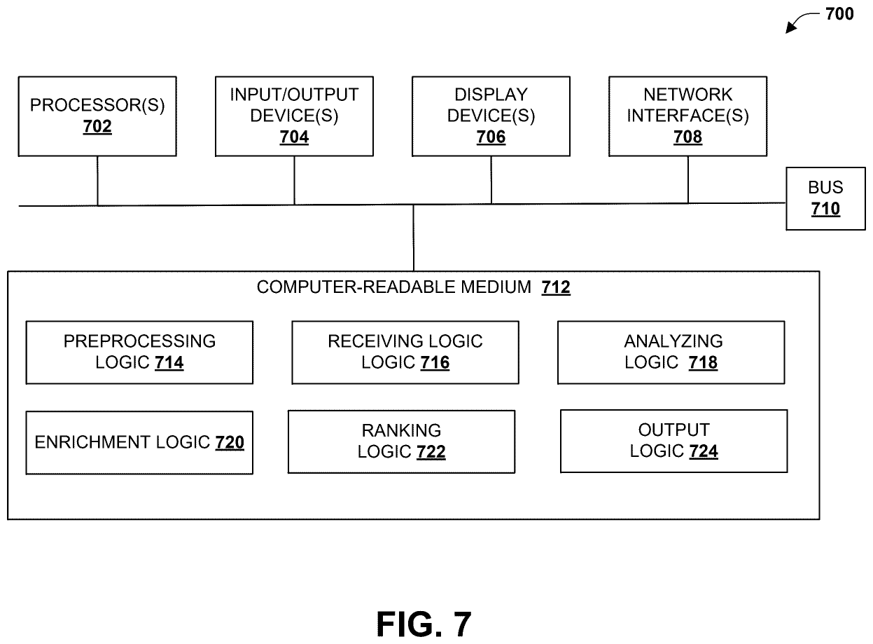

The information retrieval system 100 comprises various components including source document process component 110, resource document process component 120, data repository 130, query enrichment component 140, similarity component 150, re-rank component 160, and output generation component 170. The source document process component 110, resource document process component 120, query enrichment component 140, similarity component 150, re-rank component 160, and output generation component 170 can be implemented by at least one processor (e.g., processor(s) 702 of FIG. 7) coupled to at least one memory (e.g., memory 712 of FIG. 7) that stores instructions that cause the at least one processor to perform the functionality of each component when executed. Consequently, a computing device can be configured to be a special-purpose device or appliance that implements the functionality of the information retrieval system 100. Further, each component can implement or employ a machine-learning model to supplement or perform functionality of the component. Furthermore, all or portions of the information retrieval system 100 can be distributed across computing devices or accessible through a network service. For instance, the data repository 130 can be implemented as a network-accessible store.

The source document process component 110 is configured to analyze source documents and preprocess their content into structured representations optimized for downstream query processing. A source document is a document that a user interacts with and potentially needs assistance in completing. A source document may include predefined fields or other structured elements that a user needs to complete or fill out. One example of a source document is a tax form. The source document process component 110 can receive source documents comprising fields as input and output a structured and encoded representation of fields. Further contextual metadata for each field can be associated with the corresponding field, and preprocessed form data can be stored in a standardized format for downstream processing.

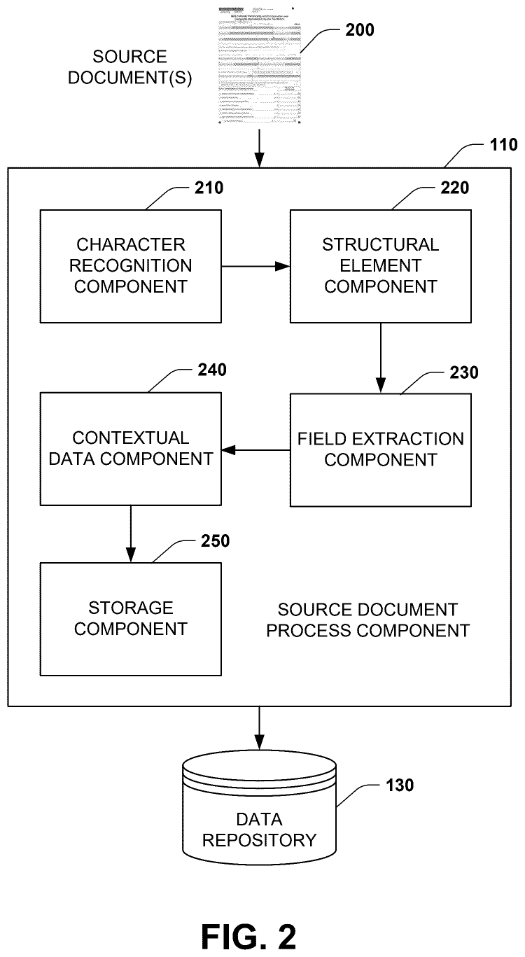

Turning to FIG. 2, an example source document process component 110 is illustrated in further detail. The source document process component 110 includes character recognition component 210, structural element component 220, field extraction component 230, contextual data component 240, and storage component 250. The source document process component 110 can receive one or more source documents 200 or forms that include one or more fields as input. The output of the source document process component 110, a structured and encoded representation of fields, can be saved to the data repository 130 for subsequent downstream query processing.

The character recognition component 210 is operable to perform optical character recognition (ORC) in order to convert an image-based source document into machine-readable text. In one example, OCR scans an image, preprocesses the image to improve image quality, and then executes text recognition through pattern matching and feature extraction. Of course, if the source document is already in machine-readable text form, then character recognition can be skipped. By digitizing text through optical character recognition, the data in a source document becomes amendable for further processing and analysis techniques as described below.

The structural element component 220 is operable to analyze a source document's layout and structure. The structural element component 220 can identify visual boundaries and fields or sections by analyzing layout cues or structural markers, such as boxes, lines, and spacing patterns (e.g., bold, highlighted, font size). Subsequently, the structural element component 220 can extract further information regarding elements such as field names, labels, and values. In one instance, the structural element component 220 can recognize field type or other metadata, such as bold text for headings. Structural elements can be associated with structural tags programmatically with corresponding sections and pages, for instance.

Further, structural relationships between elements can be encoded based on proximity and visual hierarchy (e.g., pages, outline). For example, a field can be identified as part of a section or subsection of a form based on the field's positioning and indentation level in a document layout. In another example, two fields can be determined to be related based on their close physical proximity and alignment on a page. In accordance with one embodiment, a machine learning model can be employed to at least aid in identifying structural elements. For example, object detection models can be trained to recognize visual cues, such as headings, fields, and tables, as well as styling attributes (e.g., font, size) that indicate structural elements. The output of the structural element component 220 can be structured and encoded representations of structural metadata extracted from the source document 200. For example, the output can include identified structural elements and relationships between the elements included in a standardized format such as JSON. Although not limited thereto, in accordance with one embodiment, the structural element component 220 can employ layout and task-aware instruction prompt (“LATIN-Prompt”) to extract structure or layout information within a document.

The field extraction component 230 is operable to identify fields in a source document. The field extraction component 230 can utilize structural metadata generated by the structural clement component 220 to identify field elements. More specifically, the field extraction component 230 can utilize structural cues like boundaries and other common structures to extract fields. In accordance with one embodiment, the field extraction component 230 can be a separate component from the structural element component 220. However, in an alternative embodiment, the field extraction component 230 can be implemented within the structural element component 220 as a separate sub-component.

The contextual data component 240 is configured to analyze content to derive additional contextual metadata beyond structural attributes. In accordance with one embodiment, natural language processing (NPL) techniques (e.g., word embeddings, named entity recognition, topic modeling) can be employed to identify related concepts and semantic associations. For example, dates can be recognized, and elements can be linked based on references, citations, or other connections. The contextual data component 240 can output metadata regarding derived semantic relationships and conceptual associations.

As an example, suppose a tax form is input as the source document 200. If necessary, OCR can be performed by the character recognition component 210 to convert an image-based tax form into machine-readable text. The structural element component 220 can analyze the visual layout or formatting of the machine-readable text and extract structural metadata like sections (e.g., header, personal information, income, deductions, tax, signature). The field extraction component 230 can utilize the structural metadata to identify fields in the tax form, such as name and income, and add the fields to the structural metadata. The contextual data component 240 analyzes identified fields and adds semantic metadata. For instance, the contextual data component 240 can determine that a particular field or set of fields is related to a concept like taxable income. A field can be determined to relate to taxable income based on a number of factors, including direct reference, such as the field name being taxable income, location in a section related to income reporting, and surrounding text conceptually related to taxable income. The output can include structural and conceptual metadata, or contextual metadata, which captures sections, regions, and fields tagged with attributes (e.g., names, labels) and semantic associations related to the fields (e.g., taxable income).

The storage component 250 is operable to save the output of character recognition component 210, structural element component 220, field extraction component 230, and contextual data component 240 to data repository 130. More specifically, generated contextual metadata (e.g., structure and concepts) can be saved for subsequent use in responding to queries regarding fields. In one embodiment, contextual metadata can be encoded as an embedding. Alternatively, the contextual metadata can be in another structured format, such as JSON (JavaScript® Object Notation).

Returning to FIG. 1, the resource document process component 120 is operable to analyze and preprocess resource documents to generate structured representations to facilitate subsequent query processing. Resource documents can include instructions, guidelines, bulletins, or the like that aid understanding and completion of fields of a source document. The resource document process component 120 can operate similarly to the source document process component 110, but with some differences, given that resource documents are unstructured in nature and lack fields. The output of the resource document process component 120 can be a structured and encoded representation of passages of source documents with associated contextual metadata. For example, segmented passages of resource document text can be produced, and each passage can include contextual attributes as metadata. The contextual attributes can include structural metadata such as headings, formatting, and position, and conceptual or semantic metadata such as topics, entities, and relationships. The output corresponds to context-aware chunking of data in which resource documents are segmented or chunked without losing context, including relationships between chunks. In one instance, each passage and contextual metadata can be represented as an embedding. For example, a first embedding can be generated for passage content, a second embedding can be generated for contextual attributes, and the first and second embeddings can be combined to produce a single embedding that represents both the content and context of the passage.

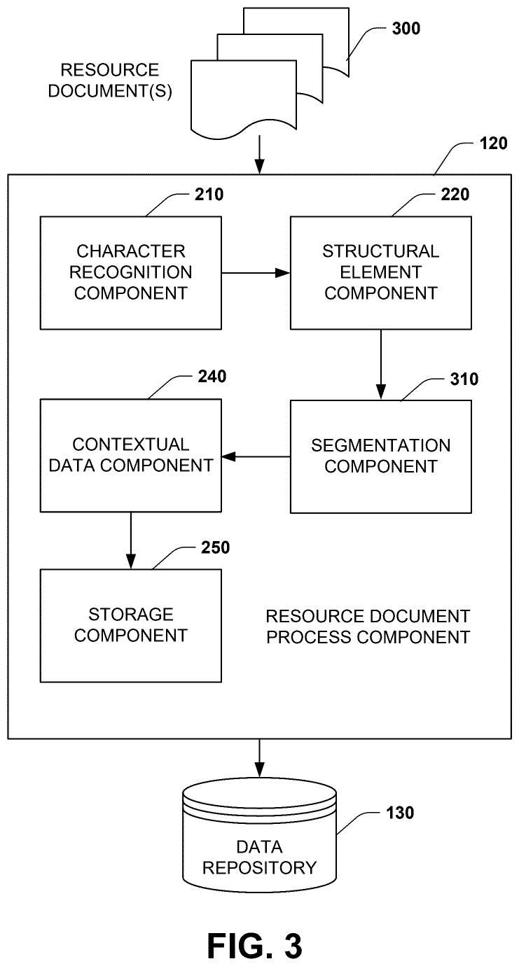

Turning to FIG. 3, an example resource document process component 120 is illustrated in further detail. The resource document process component 120 receives one or more resource documents 300 as input. Similar to the source document process component 110 of FIG. 2, the resource document process component 120 includes the character recognition component 210, structural element component 220, contextual data component 240, storage component 250, and data repository 130. In brief, the character recognition component 210 performs optical character recognition on an image to produce computer-readable text, the structural element component 220 is operable to identify structural elements and relationships between the elements, and the storage component 250 is operable to save representations of resource documents including contextual metadata to the data repository 130. The resource document process component 120 also includes segmentation component 310.

The segmentation component 310 is operable to logically divide unstructured text of a reference document into segments or passages. The segmentation component 310 can exploit structural element analysis of formatting cues, such as headers, to hierarchically segment a document. Contextual metadata can be determined by the contextual data component 240 and attached to passages by identifying associated headings and structural attributes. The segmented passages and metadata can then be encoded and saved to the data repository 130 by the storage component 250. The segmentation component 310 is able to partition reference text logically and differs from field extraction component 230 of FIG. 2, which seeks to identify and define structured data elements. In other words, segmentation operates at a text segment or passage level rather than individual fields.

Returning to FIG. 1, the output of source document process component 110 and resource document process component 120 is saved to the data repository 130, as also depicted and described in FIGS. 2 and 3. The data repository 130 is a non-volatile store that can be local or remote with respect to other components, and it includes fields, passages, and metadata. In one instance, the data repository 130 can be a key-value store, indexed by a field identifier for source document data. In another instance, the data repository can be a vector database that stores vector embedding associated with fields and passages. The query enrichment component 140 and the similarity component 150 are operable to interact with the data repository to retrieve data.

The query enrichment component 140 is operable to analyze an incoming natural language query and augment the query with relevant contextual metadata. The query enrichment component 140 can first apply natural language processing (NLP) techniques to identify any reference to a field or set of fields (e.g., related by context or layout). In one embodiment, a field identifier can be sent as metadata with the query. For example, if a user is interacting with an electronic version of a form and the cursor is in a field without data prior to a query, the field can be sent as metadata with the query. Relevant structural and conceptual metadata associated with an identified field can be acquired from the data repository 130. The query text and the metadata can be combined, wherein the structural and conceptual, or in other words, contextual metadata, enriches the original query. For example, suppose a query is specified that relates to a tax form field that refers to total deductions. Contextual metadata regarding the field can include reference to “Schedule A: Computation of Tax—Total Deductions from page 1, Schedule B, line 1.” In one embodiment, an embedding can be generated for the enriched query. An embedding is a numerical representation, such as a vector, of values or objects like text. A machine learning model can be employed to generate an embedding that represents an enriched query.

The similarity component 150 is operable to receive an enhanced query and determine the similarity between the query and passages associated with reference documents like instructions or guides. In accordance with one embodiment, the enhanced query and the passages are encoded as embeddings, and the similarity component 150 can calculate similarity scores (e.g., cosine similarity) between a query embedding and each document embedding. The similarity component 150 can return a passage associated with the greatest similarity score as the response to the query. Alternatively, the similarity component 150 can return a set of two or more passages associated with the greatest similarity score. For example, the top five ranked passages based on similarity score can be returned.

The re-rank component 160 receives a set of results from the similarity component 150 and further filters or refines the responses. The top passages returned by the similarity component 150 can be re-evaluated to re-rank potential responses. In one embodiment, a machine learning model, such as a large language model, can be utilized to analyze the content of the top passages and re-order the results based on how well each result addresses the specific information needed to satisfy the query. A passage can be automatically upranked (e.g., promoted) or downranked (e.g., demoted) based on how well the passage addresses the query. In this manner, the information retrieval system 100 can return the most applicable responses by improving the accuracy over similarity matching alone.

The information retrieval system 100 captures and exploits contextual metadata derived from document structure and conceptual relationships to improve the accuracy of content returned in response to a query. A query can be enriched with contextual data about a target field to enable queries to be mapped precisely to relevant passages that assist users in understanding and completing the field. Expedited query response times are also enabled by preprocessing source and resource documents to extract fields, passages, and associated metadata. Furthermore, re-ranking initially retrieved results with a machine learning model further improves the relevancy and precision of the resultant passage or set of passages. Re-ranking can also enhance efficiency by returning the most relevant information without providing a large number of passages for a user to read.

### Example Method of Source Document Processing

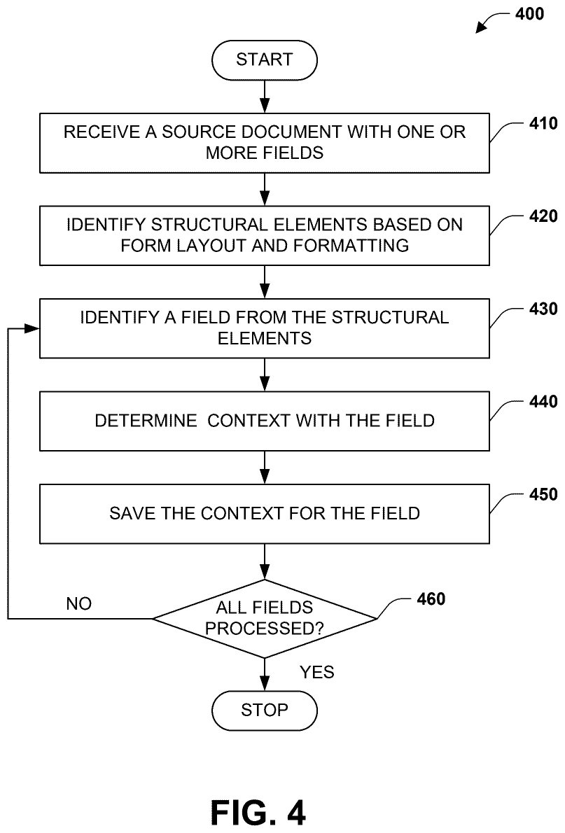

FIG. 4 depicts an example method 400 of source document processing. In one aspect, method 400 can be implemented by source document process component 110 of FIGS. 1 and 2, and the processing apparatus of FIG. 7.

The method 400 starts at block 410 by receiving a source document with one or more fields. In accordance with one embodiment, the source document can correspond to a form, such as a tax form, with a number of fields. A field refers to an individual data entry point where users can provide data, such as a date, number, or text. Although not shown, if a source document is in an image format, the source document image can be converted to a computer-readable format using optical character recognition to extract text and layout through the character recognition component 210 of FIG. 2.

The method 400 proceeds to block 420 with identifying structural elements in the source document based on layout and formatting of the document. Structural elements refer to components of a document's visual structure and organization. For example, structural elements can include, but are not limited to, headings, subheadings, paragraph breaks, lists or other passage delineators, tables, figures, and other embedded informative elements. The structural elements can be identified by analyzing the layout and formatting of a document, such as bolding, capitalization, element size, indentation, and spatial relationships based on positioning on a page. In accordance with one embodiment, a machine learning model can be executed to predict structural elements based on visual cues. The functionality of block 420 can be performed by the structural element component 220 of FIG. 2.

The method 400 next proceeds to block 430 with identifying a field from structural elements. Structural elements can further be analyzed to identify fields in a document. In one instance, characteristics of a field, such as field labels and visually bounded areas without data, can be exploited to identify a field. In accordance with one embodiment, an object detection machine-learning model can be employed to identify a field based on training data that allows the model to learn characteristics of a field. The functionality of block 430 can be performed by the field extraction component 230 of FIG. 2.

The method 400 continues at block 440 with determining a context associated with an identified field. The context for a field can be determined based on the structural element analysis and natural language processing. By analyzing identified structural elements, a physical context can be determined based on its location, for example, in a particular section or table based on visual proximity or boundaries. Further, natural language processing of text surrounding a field can be utilized to determine conceptual relationships. For example, based on a field label, surrounding text, or both, it can be determined that a field is related to a total deduction dollar amount. In one embodiment, a machine learning model can be trained and employed to determine the contextual metadata. The functionality of block 440 can be performed by the contextual data component 240 of FIG. 2.

The method 400 continues at block 450 with saving the context for the field. Determined context can then be associated with a field, for example, utilizing a structured data format to store a link between a field and context attributes. In another embodiment, an embedding can be generated by a machine learning model that represents the context for the field. The context regarding the field can be utilized for subsequent processing, such as enriching a query and matching content. The functionality of block 450 can be performed by the storage component 250 of FIG. 2.

The method 400 continues at block 460, where a determination is made as to whether all fields have been processed. In other words, the determination concerns whether all identified fields have had context determined and saved. If all fields have not been processed (“NO”), the method 400 can loop back to block 430 to process the next field. If all fields have been processed (“YES”), the method 400 terminates. Subsequent processing can be initiated with respect to another source document or form.

Method 400 provides technical benefits and a technical solution to technical problems associated with information retrieval, including returning inaccurate or irrelevant responses, for example, given resource content including similar but subtly different concepts. Identifying fields, and linking attributes about relationships and meaning enables context to be employed downstream. Queries can be more precisely matched to pertinent content based on contextual metadata associated with a field. Further, processing can be more efficient than repeating processing by saving and retrieving field contextual metadata, which also expedites response times to user queries.

Note that FIG. 4 is just one example of a method, and other methods including fewer, additional, or alternative steps are possible consistent with this disclosure.

### Example Method of Resource Document Processing

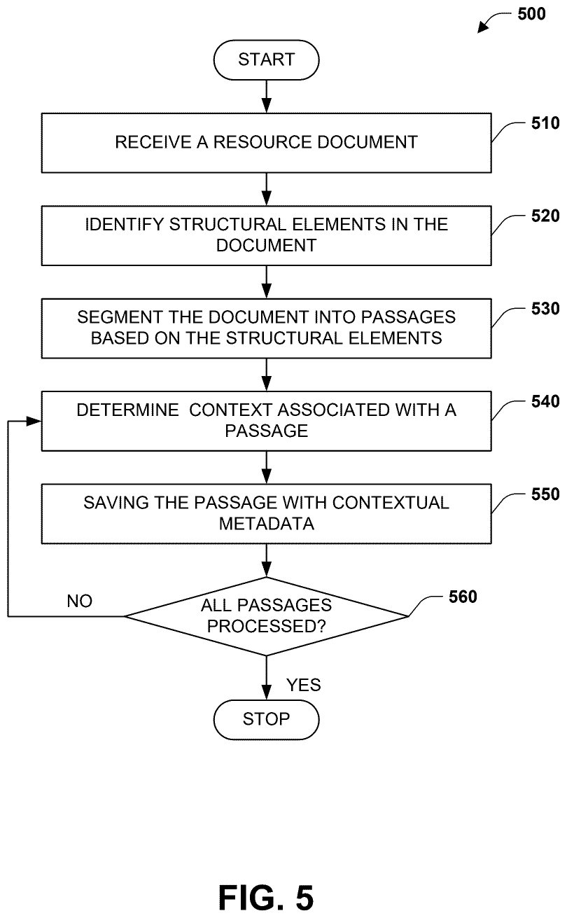

FIG. 5 depicts an example method 500 of resource document processing. In one aspect, method 500 can be implemented by resource document process component 120 of FIGS. 1 and 3, and the processing apparatus of FIG. 7.

The method 500 starts at block 510 by receiving a resource document with one or more fields. In accordance with one embodiment, the resource document can correspond to reference materials related to source documents or forms, such as instructions, guidelines, bulletins, or other documents. A resource document can include unstructured text, among other things. Although not shown, if a resource document is in an image format, the resource document image can be converted to a computer-readable format using optical character recognition to extract text and layout through the character recognition component 210 of FIG. 3.

The method 500 proceeds to block 520 with identifying structural elements in the resource document based on layout and formatting of the document. Structural elements refer to components of a document's visual structure and organization. For example, structural elements can include, but are not limited to, headings, subheadings, paragraph breaks, lists or other passage delineators, tables, figures, and other embedded informative elements. The structural elements can be identified by analyzing the layout and formatting of a document, such as bolding, capitalization, element size, indentation, and spatial relationships based on positioning on a page. In accordance with one embodiment, a machine learning model can be executed to predict structural elements based on visual cues. The functionality of block 520 can be performed by the structural element component 220 of FIG. 3.

The method 500 continues to block 530 with segmenting the resource document into passages based on the structural elements. Boundary points can be determined based on structural elements such as headings, lists, or indentation levels that delineate logical sections. The resource document can be segmented by the boundary points. Subsequently, the segmented resource document can be used to group text into passages such as one or more paragraphs. By exploiting structural elements or visual cues, a resource document can be partitioned into a number of passages. In accordance with one embodiment, a machine learning model can be trained and employed to segment a document into passages automatically. Functionality of the block 530 can be implemented by the segmentation component 310 of FIG. 3.

The method 500 continues at block 540 with determining a context associated with a passage. The context for a passage can be determined based on the structural element analysis and natural language processing. By analyzing identified structural elements, a physical context can be determined based on its location, for example, in a particular section or table based on visual proximity or boundaries. Further, natural language processing of passage text and surrounding text can be utilized to determine semantic meaning and conceptual relationships. For example, based on a field label, surrounding text, or both, it can be determined that a field is related to a total deduction dollar amount. In one embodiment, a machine learning model can be trained and employed to determine the contextual metadata. The functionality of block 440 can be performed by the contextual data component 240 of FIG. 3.

The method 500 continues at block 550 with saving the passage with contextual metadata. Determined context can then be associated with a passage, for example, utilizing a structured data format to store a link between a passage and context attributes. In another embodiment, an embedding can be generated by a machine learning model that represents the passage and context. The context regarding the field can be utilized for subsequent processing, such as by matching content to a query. The functionality of block 550 can be implemented by the storage component 250 of FIG. 3.

The method 500 next proceeds at block 560, where a determination is made as to whether all passages have been processed. In other words, the determination concerns whether all identified passages have had context determined and saved. If all passages have not been processed (“NO”), the method 500 can loop back to block 540 to process the next passage. If all passages have been processed (“YES”), the method 500 terminates. Subsequent processing can be initiated with respect to another resource document.

Method 500 provides technical benefits and a technical solution to technical problems associated with information retrieval, including returning inaccurate and irrelevant responses, for instance, when the resource content comprises similar but subtly different concepts. Pre-extracting meaningful passages and linking those passages with associated contextual information enables precise matching of queries to passages and, thus, more accurate responses. Further, computationally expensive analysis for each query can be avoided by storing such information for reference, resulting in more efficient processing and expeditious response times than possible if the analysis is performed for each query.

Note that FIG. 5 is just one example of a method, and other methods including fewer, additional, or alternative steps are possible consistent with this disclosure.

### Example Method of Information Retrieval

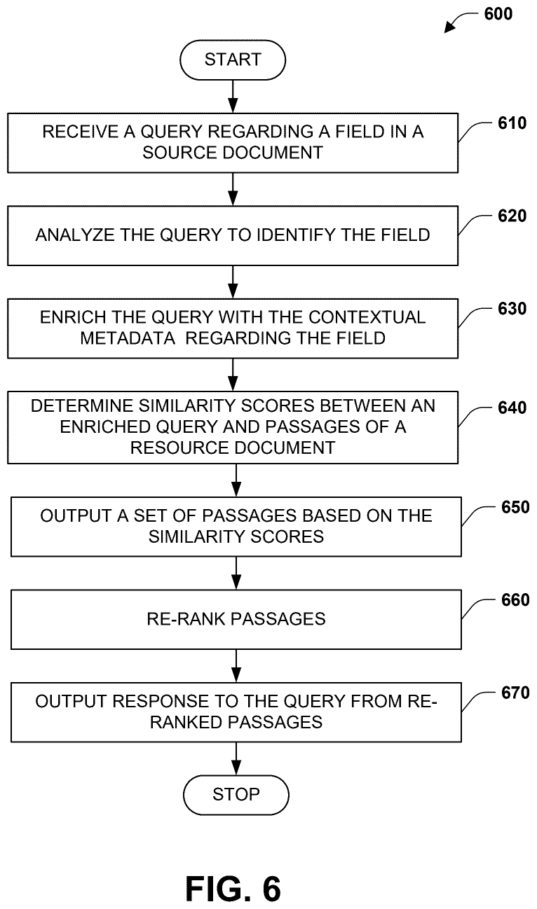

FIG. 6 depicts an example method 600 of information retrieval. In one aspect, method 600 can be implemented by information retrieval system 100 of FIG. 1 and the processing apparatus of FIG. 7.

Method 600 starts at block 610, with receiving a query regarding a field in a source document. The query can be input by a human user in natural language requesting further information regarding a field. For example, the field may pertain to a tax deduction amount, and the user may be unsure what qualifies as a tax deduction. Additionally, the query can be automatically generated. For example, if a field is active based on a user selection and a threshold time has passed without any received input, a general query can be generated, such as “Provide further information regarding what qualifies as a deduction,” to provide further information regarding the field. In one instance, previous queries can be saved and utilized to generate the automatic query. For example, the most popular query for a field can be used to return further information automatically.

The method 600 continues at block 620 with analyzing the query to identify a field. Natural language processing techniques can be utilized to determine whether the text of the query refers to a specific field. If so, the referenced field is the identified field. In another instance, the query can include metadata that specifies the field and the field can be identified based on analysis of the query metadata. For example, prior to submission of the query, metadata can be added to the query to indicate an active field at the time the query was drafted. In another instance, a user may be required to specify a field to which the query pertains, which can be included in the metadata. Regardless of how it is determined, a field associated with the query is identified.

The method 600 next proceeds to block 630, with enriching the query with contextual metadata regarding the field. Contextual metadata regarding a field can be stored in a data repository as part of the preprocessing of a source document. The contextual metadata or context attributes can be received from a data repository by referencing a source document and field. After the context is received, it can be combined with the query to generate an enhanced query. In accordance with one embodiment, a query embedding can be produced to represent the enhanced query that captures query and contextual metadata. In one instance, the contextual metadata can be stored and encoded as an embedding, the query can be encoded as an embedding, and the enhanced query corresponds to the combination of the embeddings. A machine learning model can be employed to produce the embedding.

The method 600 continues at block 640 with determining similarity scores between an enriched query and passages of resource documents. In one instance, the enriched query is represented by a query embedding, and the passages are represented by a passage embedding. Conceptually, a similarity score can be determined by computing the difference between the query embedding and multiple passage embeddings, where a small difference corresponds to similarity, and a large difference corresponds to dissimilarity. In accordance with one embodiment, the embeddings are vectors, and cosine similarity can be utilized to measure the angle between two vectors to generate a similarity score. The similarity scores enable identification of passages that are most relevant to an input query.

The method 600 continues to block 650 with outputting a set of passages based on the similarity scores. A similarity score threshold can be employed to identify a set of the most relevant passages to a query. In other words, if a passage embedding satisfies the threshold, it is added to the set of most relevant passages and is otherwise excluded from the set. Each passage in the set of the most relevant passages is output for further processing.

The method 600 next proceeds to block 660, with re-ranking the passages output by block 650. In accordance with one embodiment, a machine learning model, such as a large language model, can be employed to rank the relevancy of the passages to the query. For example, the machine learning model can be provided with a set of passages that passed a similarity threshold and asked to rank the set of passages based on relevancy to the query. In this manner, additional machine-learning reasoning can be applied to refine the initial set of passages, resulting in improved relevance and responsiveness to the original query. Further, a machine learning model is employed efficiently to re-order top results without requiring a user to consider a large number of passages.

The method continues at block 670, with outputting a response to the query from the re-ranked passages. The output can be the highest-ranking passage or set of passages that provide targeted information to a user to address the original query.

The method 600 provides technical benefits and provides a technical solution to technical problems associated with information retrieval, including returning inaccurate or irrelevant responses when resource content comprises similar but subtly different concepts. The method 600 exploits contextual metadata derived from source and resource document structure and layout to map queries to relevant informational content precisely. Overall, the ability to understand and associate contextual information provides significant improvements in the accuracy of query responses. Furthermore, utilizing information from preprocessed source documents and resource documents enables efficient processing and expeditious responses.

Note that FIG. 6 is just one example of a method, and other methods including fewer, additional, or alternative steps are possible consistent with this disclosure.

### Example Processing System for Prompt Optimization

FIG. 7 depicts an example processing system 700 configured to perform various aspects described herein, including, for example, methods 400, 500, and 600 as described above with respect to FIGS. 4-6, respectively.

Processing system 700 is generally an example of an electronic device configured to execute computer-executable instructions, such as those derived from compiled computer code, including without limitation personal computers, tablet computers, servers, smartphones, smart devices, wearable devices, augmented and/or virtual reality devices, and others.

In the depicted example, processing system 700 includes one or more processors 702, one or more input/output devices 704, one or more display devices 706, one or more network interfaces 708 through which processing system 700 is connected to one or more networks (e.g., a local network, an intranet, the Internet, or any other group of processing systems communicatively connected to each other), and one or more memories and/or computer-readable mediums 712. In the depicted example, the aforementioned components are coupled by one or more buses, which may generally be configured for data exchange amongst the components. Bus(es) 710 may be representative of multiple buses, while only one is depicted for simplicity.

Processor(s) 702 are generally configured to retrieve and execute instructions stored in one or more memories, including local memory(ies)/computer-readable medium(s) 712, as well as remote memories and data stores. Similarly, processor(s) 702 are configured to store application data residing in local memory(ies)/computer-readable medium(s) 712, as well as remote memories and data stores. More generally, bus(es) 710 is configured to transmit programming instructions and application data among the processor(s) 702, display device(s) 706, network interface(s) 708, and/or memory(ies)/computer-readable medium(s) 712. In certain embodiments, processor(s) 702 are representative of one or more central processing units (CPUs), graphics processing units (GPUs), tensor processing units (TPUs), accelerators, and other general or special-purpose processing devices.

Input/output device(s) 704 may include any device, mechanism, system, interactive display, and/or various other hardware and software components for communicating information between processing system 700 and a user of processing system 700. For example, input/output device(s) 704 may include input hardware, such as a keyboard, touch screen, button, microphone, speaker, and/or other device for receiving inputs from the user and sending outputs to the user.

Display device(s) 706 may generally include any device configured to display data, information, graphics, user interface elements, and the like to a user. For example, display device(s) 706 may include internal and external displays, such as an internal display of a tablet computer or an external display for a server computer or a projector. Display device(s) 706 may further include displays for devices, such as augmented, virtual, and/or extended reality devices. In various embodiments, display device(s) 706 may be configured to display a graphical user interface.

Network interface(s) 708 provide processing system 700 with access to external networks and thereby to external processing systems. Network interface(s) 708 can generally be any hardware and/or software capable of transmitting and/or receiving data via a wired or wireless network connection. Accordingly, network interface(s) 708 can include a communication transceiver for sending and/or receiving any wired and/or wireless communication.

Memory(ies) computer-readable medium(s) 712 may include a volatile memory, such as a random access memory (RAM), or a non-volatile memory, such as non-volatile random access memory (NVRAM), or the like. In this example, memory(ies)/computer-readable medium(s) 712 includes preprocessing logic 714, receiving logic 716, analyzing logic 718, enrichment logic 720, ranking logic 722, and output logic 724. The preprocessing logic 714 pertains to preprocessing source documents and resource documents prior to receipt of a query. The preprocessing logic 714 preprocesses source documents (e.g., form) and resource documents (e.g., instructions, guidelines). The receiving logic 716 can receive or retrieve a query. The analyzing logic 718 can analyze a query to identify an associated field. The enrichment logic 720 can receive context regarding a field and add the context to a query to generate an enhanced query. The ranking logic 722 refers to determining and ranking relevant passages from resource documents to the query. The ranking logic 722 can also encompass re-ranking utilizing a machine-learning model. Output logic 724 determines a final output passage or set of passages and returns the final output as a response to a query.

In certain embodiments, source document process component 110 and resource document process component 120 of FIG. 1 are configured to perform the preprocessing logic 714 with respect to a source document or resource document, respectively.

In certain embodiments, information retrieval system 100 of FIG. 1 is configured to implement the receiving logic 716.

In certain embodiments, information retrieval system 100 of FIG. 1 is configured to implement the analyzing logic 718.

In certain embodiments, query enrichment component 140 of FIG. 1 is configured to perform the enrichment logic 720.

In certain embodiments, the similarity component 150 and re-rank component 160 of FIG. 1 are configured to perform the ranking logic 722.

In certain embodiments, the output generation component 170 of FIG. 1 is configured to perform the output logic 724.

Note that FIG. 7 is just one example of a processing system consistent with aspects described herein, and other processing systems having additional, alternative, or fewer components are possible consistent with this disclosure.

### EXAMPLE CLAUSES

Implementation examples are described in the following numbered clauses:
Clause 1: A method comprising receiving a query regarding a source document that comprises one or more fields, determining a field of the one or more fields referenced by the query, retrieving contextual metadata for the field, generating an enriched query by adding the contextual metadata to query text, generating a query embedding from the enriched query, determining similarity scores between the query embedding and passage embeddings, wherein the passage embeddings are based on passage text from one or more resource documents comprising contextual metadata, and identifying one or more passages based on the similarity scores that satisfy a threshold.
Clause 2: The method of Clause 1, further comprising determining structural elements from the source document, identifying the field in the source document based on the structural elements, and determining the contextual metadata associated with the field.
Clause 3: The method of Clauses 1-2, further comprising executing a machine learning model to identify the field and determine the contextual metadata.
Clause 4: The method of Clauses 1-3, further comprising identifying structural elements in a resource document of the one or more resource documents, segmenting the resource document into passages of text based on the structural elements, determining contextual metadata for each passage based on the structural elements and passage text, and generating the passage embeddings of each passage that include corresponding passage text and contextual metadata.
Clause 5: The method of Clauses 1-4, further comprising ranking the one or more passages with a large language model based on the query, the field, and the contextual metadata for the field.
Clause 6: The method of Clauses 1-5, further comprising prompting the large language model to generate a response to the query based on the rankings of the one or more passages, and returning the response.
Clause 7: The method of Clauses 1-6, wherein the source document is a tax form and the field is a tax form field.
Clause 8: The method of Clauses 1-7, wherein at least one of the one or more resource documents comprises instructions for completing the source document.
Clause 9: A method comprising performing optical character recognition of a reference document to identify text, analyzing a layout of the reference document to identify one or more structural elements, segmenting the text of the reference document into passages based on the one or more structural elements, determining contextual metadata for each passage based on passage text and the one or more structural elements, and generating a passage embedding of the text and the contextual metadata for each passage in the reference document.
Clause 10: The method of Clause 9, further comprising performing optical character recognition on a source document to identify text, analyzing a layout of the reference document to identify one or more structural elements, identifying one or more fields based on the structural elements, and determining contextual metadata for each of one or more fields.
Clause 11: The method of Clauses 9-10, further comprising receiving a query with respect to the source document, identifying a field associated with the query in the source document, generating an enhanced query by adding contextual metadata associated with the field to the query, and generating a query embedding from the enhanced query.
Clause 12: The method of Clauses 9-11, further comprising determining similarity scores between the query embedding and two or more passage embeddings and identifying a set of passages based on the similarity score.
Clause 13: A processing system comprising one or more memories comprising computer-executable instructions; and one or more processors configured to execute the computer-executable instructions and cause the processing system to perform a method in accordance with any one of Clauses 1-12.
Clause 14: A processing system, comprising means for performing a method in accordance with any one of Clauses 1-12.
Clause 15: A non-transitory computer-readable medium storing program code for causing a processing system to perform the steps of any one of Clauses 1-12.
Clause 16: A computer program product embodied on a computer-readable storage medium comprising code for performing a method in accordance with any one of Clauses 1-12.

### ADDITIONAL CONSIDERATIONS

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various elements, steps, or components as appropriate. For instance, the methods described may be performed in an order different from that described, and various actions may be added, omitted, or combined. Also, features described with respect to some examples may be combined in other examples. For example, an apparatus may be implemented, or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules, method steps, and flow components described in the present disclosure may be implemented or performed with a general-purpose processor, a special-purpose processor (e.g., an artificial intelligence processor), combinations of general-purpose and special-purpose processors, and other programmable logic devices, or any combination thereof. A general-purpose processor may be a microprocessor, a commercially available processor, a controller, a microcontroller, or a state machine. A processor may also be implemented as a combination of computing devices.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., in a table, a database, or another data structure), ascertaining, and the like. Also, “determining” may include receiving (e.g., receiving information), accessing (e.g., accessing data in a memory), and the like. Also, “determining” may include resolving, selecting, choosing, establishing, and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling through an intermediary aspect, such as one or more buses.

The methods disclosed herein comprise one or more actions to achieve the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to, general- and special-purpose processors.

The following claims are not intended to be limited to the aspects shown herein, but are to be accorded the full scope consistent with the language of the claims. Reference to an element in the singular is not intended to mean only one element unless specifically so stated, but rather “one or more” elements. The subsequent use of a definite article (e.g., “the” or “said”) with respect to an element (e.g., “the processor”) is not intended to limit the claim to an interpretation requiring only a single element (e.g., “only one processor”) unless otherwise specifically stated. For example, reference to an element (e.g., “a processor,” “a controller,” “a memory,” “the processor,” “the controller,” “the memory,” etc.), unless otherwise specifically stated, should be understood to refer to one or more elements (e.g., “one or more processors,” “one or more controllers,” “one or more memories,” etc.).

The terms “set” and “group” in the claims are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., a system, a processing system, or an apparatus) to perform functions, one element may be configured to cause the other element to perform all functions, or more than one element may collectively be configured to cause the other element to perform the functions.

Unless specifically stated otherwise, the term “some” refers to one or more.

All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public, regardless of whether such disclosure is explicitly recited in the claims.

What is claimed is:

1. A method, comprising:
receiving a query regarding a source document that comprises one or more fields;
determining a field of the one or more fields referenced by the query;
retrieving contextual metadata for the field;
generating an enriched query by adding the contextual metadata to query text;
generating a query embedding from the enriched query;
determining similarity scores between the query embedding and passage embeddings, wherein the passage embeddings are based on passage text from one or more resource documents comprising contextual metadata; and
identifying one or more passages based on the similarity scores that satisfy a threshold.

2. The method of claim 1, further comprising:
determining structural elements from the source document;
identifying the field in the source document based on the structural elements; and
determining the contextual metadata associated with the field.

3. The method of claim 2, further comprising executing a machine learning model to identify the field and determine the contextual metadata.

4. The method of claim 1, further comprising
identifying structural elements in a resource document of the one or more resource documents;
segmenting the resource document into passages of text based on the structural elements;
determining contextual metadata for each passage based on the structural elements and passage text; and
generating the passage embeddings of each passage that include corresponding passage text and contextual metadata.

5. The method of claim 1, further comprising ranking the one or more passages with a large language model based on the query, field, and contextual metadata for the field.

6. The method of claim 5, further comprising:
prompting the large language model to generate a response to the query based on the rankings of the one or more passages; and
returning the response.

7. The method of claim 1, wherein the source document is a tax form and the field is a tax form field.

8. The method of claim 1, wherein at least one of the one or more resource documents comprises instructions for completing the source document.

9. A processing system, comprising:
one or more processors; and
one or more memories coupled to the one or more processors comprising computer-executable instructions that, when executed by the one or more processors, cause the processing system to:
determine a field associated with a query regarding a source document that comprises one or more fields;
retrieving contextual metadata for the field;
generate an enriched query by adding the contextual metadata to query text;
generate a query embedding from the enriched query;
determine similarity scores between the query embedding and passage embeddings, wherein the passage embeddings are based on passage text from one or more resource documents comprising contextual metadata; and
identify one or more passages based on the similarity scores that satisfy a threshold.

10. The processing system of claim 9, wherein the instructions further cause the processor to:
determine structural elements from the source document;
identify the field in the source document based on the structural elements; and
determine the contextual metadata associated with the field.

11. The processing system of claim 10, wherein the instructions further cause the execute a machine learning model to identify the field and determine the contextual metadata.

12. The processing system of claim 9, wherein the instructions further cause the processor to:
identify structural elements in a resource document of the one or more resource documents;
segment the resource document into passages of text based on the structural elements;
determine contextual metadata for each passage based on the structural elements and passage text; and
generate the passage embeddings of each passage that include corresponding passage text and contextual metadata.

13. The processing system of claim 9, wherein the instructions further cause the processor to rank the one or more passages with a large language model based on the query, field, and contextual metadata for the field.

14. The processing system of claim 13, wherein the instructions further cause the processor to:
prompt the large language model to generate a response to the query based on the rankings of the one or more passages; and
return the response.

15. The processing system of claim 9, wherein the source document is a tax form and the field is a tax form field.

16. The processing system of claim 15, wherein at least one of the one or more resource documents comprises instructions for completing the source document.

17. The processing system of claim 9, wherein the query comprises a set of fields related by context.

18. A method, comprising:
performing optical character recognition of a reference document to identify text;
analyzing a layout of the reference document to identify one or more structural elements;
segmenting the text of the reference document into passages based on the one or more structural elements;
determining contextual metadata for each passage based on passage text and the one or more structural elements; and
generating a passage embedding of the text and the contextual metadata for each passage in the reference document.

19. The method of claim 18, further comprising:
performing optical character recognition on a source document to identify text;
analyzing a layout of the reference document to identify one or more structural elements;
identifying one or more fields based on the structural elements; and
determining contextual metadata for each of one or more fields.

20. The method of claim 19, further comprising:
receiving a query with respect to the source document;
identifying a field associated with the query in the source document;
generating an enhanced query by adding contextual metadata associated with the field to the query;
generating a query embedding from the enhanced query;
determining similarity scores between the query embedding and two or more passage embeddings; and
identifying a set of passages based on the similarity score.
